(19) United States
(12) Patent Application Publication
(10) Pub. No.: US 2016/0248838 A1
(43) Pub. Date: Aug. 25, 2016

(54) Remoting An Application User Interface From A User Device to Another Display

(71) Applicant: VMware, Inc., Palo Alto, CA (US)

(72) Inventors: Salim AbiEzzi, Sammamish, WA (US); Osten Kit Colbert, Mountain View, CA (US)

(21) Appl. No.: 14/629,353

(22) Filed: Feb. 23, 2015

(51) Int. Cl. H04L 29/08; G06F 3/0484

(52) U.S. Cl. CPC H04L 67/025; G06F 3/0484

(57) ABSTRACT

Systems and techniques are described for remoting a user interface. A described technique includes receiving, at a user device, a user request to use a display of a display device to access an application. The application includes a respective user interface code path corresponding to each of a multitude of display device classes. Each user interface code path generates a user interface that is specific to display devices of the corresponding display device class. The user device causes the application to generate a user interface for the display of the first display device by executing a first user interface code path. The first user interface code path corresponds to a first display device class to which the first display device is classified. The user device provides a user interface for presentation on the display of the first display device in response to the user request.

### BACKGROUND

This document relates to remoting application user interfaces from user devices to other displays.

A user of a user device can interact with an application that is executed on a server remote from the user device using a remote display protocol. The remote display protocol can be used to transfer the display data generated by the application for presentation on the user device. During execution and based on user input events from the user device, the application can generate updates to the display data, and the remote display protocol can be used to transfer the updated display data to the remote client.

A virtual machine (VM) is a software-based abstraction of a physical computer system. A VM is executed on a physical computer through the use of virtualization software typically referred to as a “hypervisor.” A physical computer system, also referred to as a host machine, can execute one or more VMs. The hypervisor is software that is logically interposed between and interfaces with a VM and a physical computer system. In general, each VM is configured to execute an operating system, referred to herein as a guest OS, and applications.

### SUMMARY

In general, one aspect of the subject matter described in this document can be embodied in a technique that includes receiving, at a user device, a user request to use a display of a first display device to access an application, wherein the application includes a respective user interface code path corresponding to each of a plurality of display device classes, and wherein each user interface code path, when executed, generates a user interface that is specific to display devices of the corresponding display device class; causing, by the user device, the application to generate a user interface for the display of the first display device by executing a first user interface code path, the first user interface code path corresponding to a first display device class to which the first display device is classified; and providing, by the user device, a user interface for presentation on the display of the first display device in response to the user request.

These and other aspects can optionally include one or more of the following features. In some implementations, the application is executed on the user device. Receiving the user request can include receiving the user request from the first display device. The user request can include information describing the display and input capabilities of the first display device. Some implementations include classifying the first display device into the first display device class based on the information describing the display and the input capabilities of the first display device.

Some implementations include, while the user interface is presented on the display of the first display device, receiving, by the user device and from the first display device, data identifying a user event associated with the user interface and providing the input to the application. Some implementations include receiving, by the user device, a user interface update from the application and providing the user interface update to the first display device.

In some implementations, the application is executed by a remote application system that is in data communication with the user device and that is remote from the first display device. Some implementations include providing, to the remote application system, a user interface request that requests the generation of the user interface and that includes information describing the display and input capabilities of the first display device and receiving the user interface from the remote application system through the user device.

In some implementations, the user device includes one of a mobile phone, a tablet computer, a game console, or a television set top box. In some implementations, the first display device includes one of a vehicle-mounted display, a television, a head-mounted display, or a watch.

In some implementations, the first display device operates in a first mode and a second mode different from the first mode. The first user interface code path can correspond to the first mode. Some implementations include receiving data indicating that the mode of the first display device has changed from the first mode to the second mode and causing the application to generate an updated user interface for the display of the first display device by executing a second user interface code path that corresponds to the second mode. In some implementations, the first mode is a laptop mode and the second mode is a tablet mode. The first display device can change from the first mode to the second mode automatically in response to detection of removal of a tablet portion of the first display device from a keyboard of the display device.

Particular embodiments of the subject matter described in this document can be implemented so as to realize one or more of the following advantages. By allowing applications to execute different code paths that generate different user interfaces for devices having different display sizes and with different input methods, the user experience can be improved by allowing users to interact with different user interfaces that are adapted to the displays and input capabilities of the devices. By remoting application user interfaces from user devices to other displays (e.g., vehicle-mounted display, televisions, projectors, head-mounted displays, smart watches, and so on) in this manner, simpler displays that do not require sophisticated operating systems for hosting applications can be used to view and interact with applications. In addition, larger displays can be used to view and interact with applications that are hosted on user devices (or hosted by a remote server in data communication with the user device) that have smaller displays. Displays, such as vehicle-mounted displays, that do not have Internet connectivity can be used to display and interact with applications hosted on a remote server by way of the user device. Users of multiple displays (e.g., a dash-mounted display and a rear seat display) within a vehicle can simultaneously interact with applications executing on a user device or on a server remote from the vehicle by way of the user device.

Additionally, by using a single application having multiple user interface code paths, the user experience is improved by allowing the user to access the same centralized application data and session state from any display while also being provided with a user interface tailored for the display and its input style. Further, applications having multiple user interface code paths may be easily developed and maintained, e.g., because to allow the application to support an additional display class, only a new user interface code path corresponding to the additional display class needs to be developed. User interface designers are afforded additional flexibility in designing user interfaces for an application by being able to tailor different user interfaces to different display classes.

Remoting user interfaces may improve the functionality of a display device that presents the user interface. For large data sets, remoting a user interface instead of transmitting the actual data to the display device can involve communicating less data and can require less data storage on the display device.

By remoting the user interface rather than providing actual data that is processed and configured for presentation, the system can better secure the actual data. This remoting also allows one or more users, e.g., teams or organizations of users, to access data seamlessly from multiple device types having different characteristics.

The details of one or more embodiments of the subject matter described in this document are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example environment in which a user device provides user interfaces generated by applications to display devices.

FIG. 2 shows an example environment in which a remote application system provides user interfaces generated by applications to display devices.

FIG. 3 is a flow chart of an example technique for providing a user interface generated by an application to a display device.

FIG. 4 is a flow chart of another example technique for providing a user interface generated by an application to a display device.

Like reference numbers and designations in the various drawings indicate like elements.

### DETAILED DESCRIPTION

This document generally describes techniques for remoting a user interface. A described technique includes receiving, at a user device, a user request to use a display of a display device to access an application. The application can include a respective user interface code path corresponding to each of a multitude of display device classes. Each user interface code path can generate a user interface that is specific to display devices of the corresponding display device class. The user device can cause the application to generate a user interface for the display of the first display device by executing a first user interface code path. The first user interface code path can correspond to a first display device class to which the first display device is classified. The user device can provide a user interface for presentation on the display of the first display device in response to the user request.

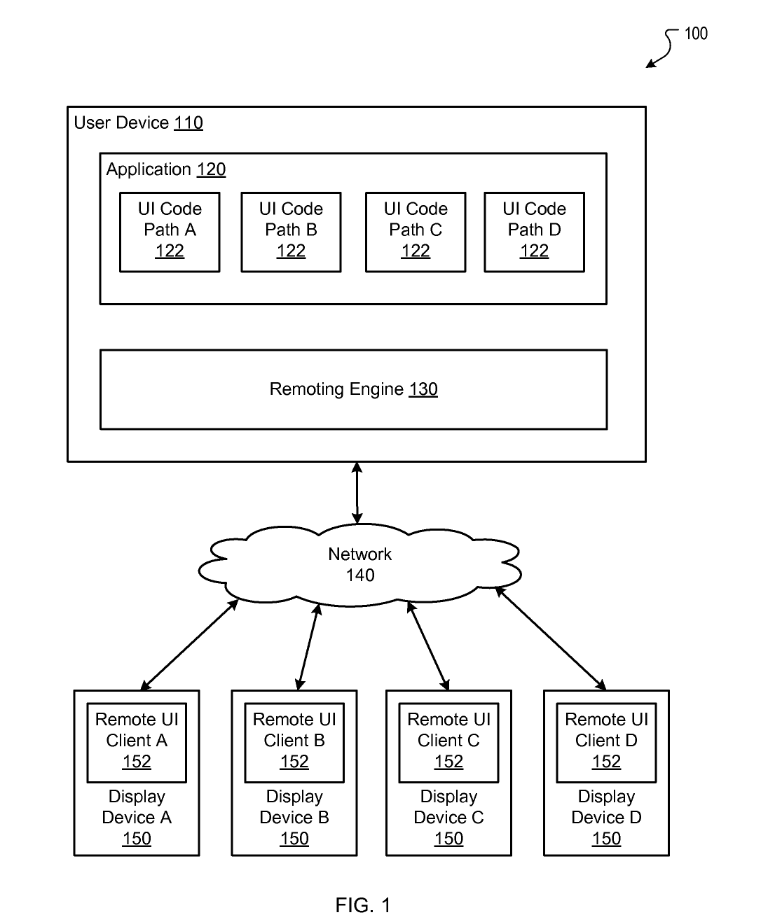

FIG. 1 shows an example environment 100 in which a user device 110 provides user interfaces generated by applications to display devices 150. The user device 110 is an electronic device that manages and/or facilitates the execution of one or more applications, e.g., software applications or operating systems. For example, the user device 110 may be a computer, laptop computer, tablet computer, smart phone, smart watch, or gaming console.

The user device 110 can include a display that allows users to access and interact with applications. The user device 110 can also allow users to access and interact with the applications managed by the user device 110 at display devices 150 different from the user device 110 by providing user interfaces generated by the applications for presentation on displays of the display devices 150. The display devices 150 can be different from and remote from the user device 110. For example, the display devices 150 may be vehicle-mounted display devices (e.g., car dash-mounted displays), televisions, conference room displays, projectors, head-mounted displays, computers, tablet computers, multimode computers that can operate as a laptop computer and as a tablet computer, or other appropriate devices having, or being associated with, a display.

In a particular example, the user device 110 is a smart phone and the display device is a vehicle-mounted display. In this example, a user can access applications installed on and/or managed by the smart phone using the vehicle-mounted display. The user device 110 can provide user interfaces for one or more applications to multiple display devices, e.g., simultaneously. Continuing the previous example, the user device 110 may provide a user interface for a navigation application or an audio player to a dash-mounted display. The user device 110 may also, e.g. simultaneously, provide a user interface for a video player application to a back-seat display for passengers of the vehicle to watch movies.

The user device 110 can provide the user interfaces using direct wired or wireless communication between the user device 110 and the display devices 150. For example, the user device 110 may communicate with the display device 150 using Bluetooth™ or another short or long range wireless technology. The user device 110 can also provide the user interfaces over a network 140. The network 140 can be, e.g., a local area network (LAN), wide area network (WAN), e.g., the Internet, a personal area network (PAN), a cellular data network, or a combination thereof.

In order to allow the users to interact with the applications, the user device 110 also receives data identifying user events associated with the presented user interfaces and provides those inputs to the applications executing on the user device 110. For example, the user device 110 can allow users of the display devices 150 to access and interact with an application 120 executing on the user device 110.

The display devices 150 can be various display devices that have various display properties and that accept various user input modalities. For example, the display devices 150 can include vehicle in-dash displays that accept touch, push button, and/or voice inputs. In another example, televisions accept pushbutton and/or remote control inputs. In yet another example, a head-mounted display may receive head movement inputs. The displays of the display devices 150 can be of varying sizes and can display outputs at various display resolutions (e.g., standard definition, high definition, ultra-high definition, and so on).

Some display devices 150 accept different types of input based on the mode of the display device 150. For example, a multimode computer can operate in a tablet mode and a laptop mode. A multimode computer may include a tablet computer that attaches to a keyboard or may include a display with a keyboard that can rotate behind the display for use in tablet mode. The multimode computer may accept touch input when the computer is in a tablet mode of operation. However, the multimode computer may only accept keyboard and mouse/touchpad input when the computer is in a laptop mode of operation. The multimode computer may switch between modes of operation automatically in response to the tablet being attached to or removed from the keyboard or in response to the keyboard being rotated behind the display or in front of the display. For example, when a removable tablet is re-attached to its keyboard, the multimode computer may automatically switch its mode from tablet mode to laptop mode.

To account for the different display and input capabilities of different kinds of display devices, the application 120 can generate and provide user interfaces to the display devices 150 based on the characteristics of the displays (e.g., size, resolution, input capabilities, and so on). For example, the application 120 may generate a respective user interface for each display device that is classified in a particular display device class.

In addition, the application 120 may generate a different respective user interface for each mode of a particular display device. For example, the application may generate a user interface configured to receive touch screen inputs when a multimode computer is in tablet mode and a different user interface when the multimode computer is in laptop mode. In this example, the icons presented on the display may differ based on the mode. For example, larger touch screen icons may be displayed in tablet mode, while smaller icons may be displayed in laptop mode. The user interface may be updated automatically in response to the mode of the multimode computer being changed. For example, the application 120 may receive data indicating that the mode has changed from laptop mode to tablet mode. In response, the application 120 may generate a user interface configured for tablet mode (e.g., with larger touch screen icons) and provide the generated user interface to replace the previously displayed laptop mode user interface.

In some implementations, the application 120 includes multiple user interface code paths 122. Each of the user interface code paths 122, when executed, generates a user interface that is specific to a respective class of display devices and/or specific to a respective mode for a class of display devices. For example, one of the user interface code paths 122 may generate a user interface for display devices that accept touch input, that have displays of specified sizes, and that display output at a specified range of resolutions. A different one of the user interface code paths 122 may generate a user interface for user devices that accept remote control input, e.g., a television's remote control input. Yet another user interface code path 122 may generate a user interface for a left eye of a head-mounted display and a user interface for a right eye of the head-mounted display. In a multimode computer example, a user interface code path may generate a user interface for tablet mode while a different user interface code path may generate a user interface for laptop mode.

To allow a user to interact with an application managed by the user device 110, each of the display devices 150 includes a respective remote user interface client 152 that users of the display device 150 can use to interact with the application 120 or with other applications executing on the user device 110. In some implementations, the remote user interface client 152 is a special-purpose application executing on the display device 152. For example, a special-purpose remote user interface client 152 may be installed on televisions, vehicle-mounted displays, and so on. In some other implementations, the remote user interface client 152 is a native application or a web browser executing on the user device 152.

In a particular example, a display device 150 may detect the presence of the user device 110 and establish communication with the user device 110. Or, the user device 110 may detect the presence of the display device 150 and establish communication with the display device 150, e.g., using Bluetooth™. Once the communication link is established, the display device 150 may identify applications, such as application 120, that are installed on the user device 110. For example, the user device 110 may provide data identifying the applications to the display device 150. In some implementations, the data may only identify applications that support remoting, e.g., applications that can generate and provide user interfaces based on the class of displays. The display device 150 can display data identifying the applications. For example, the data may be selectable icons that each identify a respective one of the applications. A user of one of the display devices 150 can submit a request to the user device 110 through the remote user interface client 152 executing on the display device 150 to access the application 120. In some implementations, the user may request to use a display device 150 using the user device 110. For example, the user may select the display device 150 from a user interface of the user device 110. In some implementations, the request may be submitted in response to user interaction with the icon for the application 120.

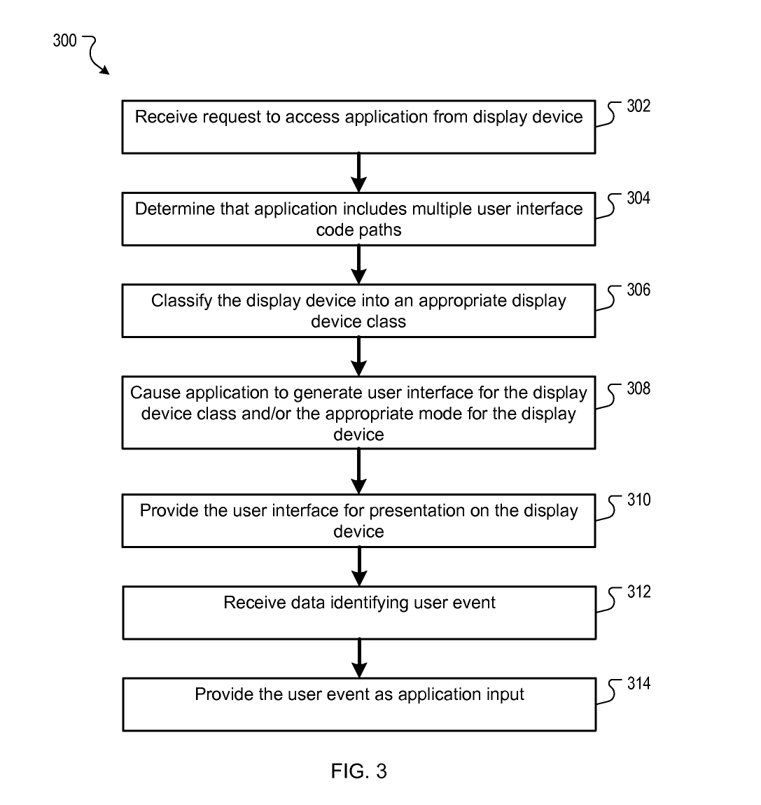

A remoting engine 130 in the user device 110 receives the request from the remote user interface client 152 to access the application 120, determines the display device class that the requesting display device belongs to and/or the mode of the display device, and causes the application 120 to generate a user interface by executing the user interface code path 122 corresponding to the display device class and/or its mode. Determining a display device class to which a display device belongs and causing an application to generate a user interface are described in more detail below with reference to FIG. 3.

The remoting engine 130 then provides the user interface generated by the application 120 to the requesting display device for presentation to the user by the remote user interface client 152 executing on the display device 150. Generally, the remoting engine 130 transmits the user interface data to the remote user interface client 152 executing on the display device 150 using a remote display protocol. In some implementations, the remote display protocol is a pixel-level protocol e.g., the Blast protocol or the remote desktop protocol (RDP), that compresses, encrypts and transports image pixels to the remote user interface client 152 executing on the display device 150. The remote user interface client 152 in turn causes the display device 150 to decrypt, decompress, and display the image pixels. In some other implementations, the remoting engine 130 can provide the user interface data using a higher-level protocol. For example, the higher-level protocol may be a protocol that provides the user interface data using a page layout language with client-side scripting, e.g., a protocol that provides the user interface data in a hypertext markup language (HTML) document with Cascading Style Sheets (CSS) and JavaScript. As another example, the higher-level protocol may be a geometry-based protocol, e.g., a graphics device interface (GDI) protocol.

While the user interface is being displayed to the user, the remote user interface client 152 is configured to detect user events associated with the displayed user interface and provide data identifying the user events to the remoting engine 130. For example, the remote user interface client 152 can detect user events, e.g., a click, touch, pushbutton, or voice input at or on the user interface or a text input submitted by a user while the user interface is active on the display device, and provide data identifying the user events to the remoting engine 130, e.g., data identifying the location of the user event, the type of the user event type, and other user event parameters.

Once the remoting engine 130 receives data identifying a user event, the remoting engine 130 provides the input to the application 120. If the user input causes a change to the user interface, the remoting engine 130 receives the updated user interface data from the application 120 and provides the updated user interface data for presentation to the user by the remote user interface client 152, e.g., using the remote display protocol.

In some implementations, applications may be managed by remote application systems, e.g., servers in the cloud. In such implementations, when an application to be remoted from a user device to a display device is actually executed by a remote application system, the user device may facilitate the remoting of user interfaces and data regarding user events between the remote application system and the display device. For example, some display devices may not be connected to a network, e.g., the Internet, to communicate with remote application systems. User devices, e.g., smart phones, tablet computers, and so on, can provide a communication path between the remote application systems and display devices.

In some implementations, a display device may be in data communication with the remote application systems, e.g., directly without the use of a user device. For example, a smart television may be connected to the remote application system over the Internet using a wireless module connected to a wi-fi router. In such implementations, the remote application system may provide user interfaces directly to the display devices and receive user events directly from the display devices.

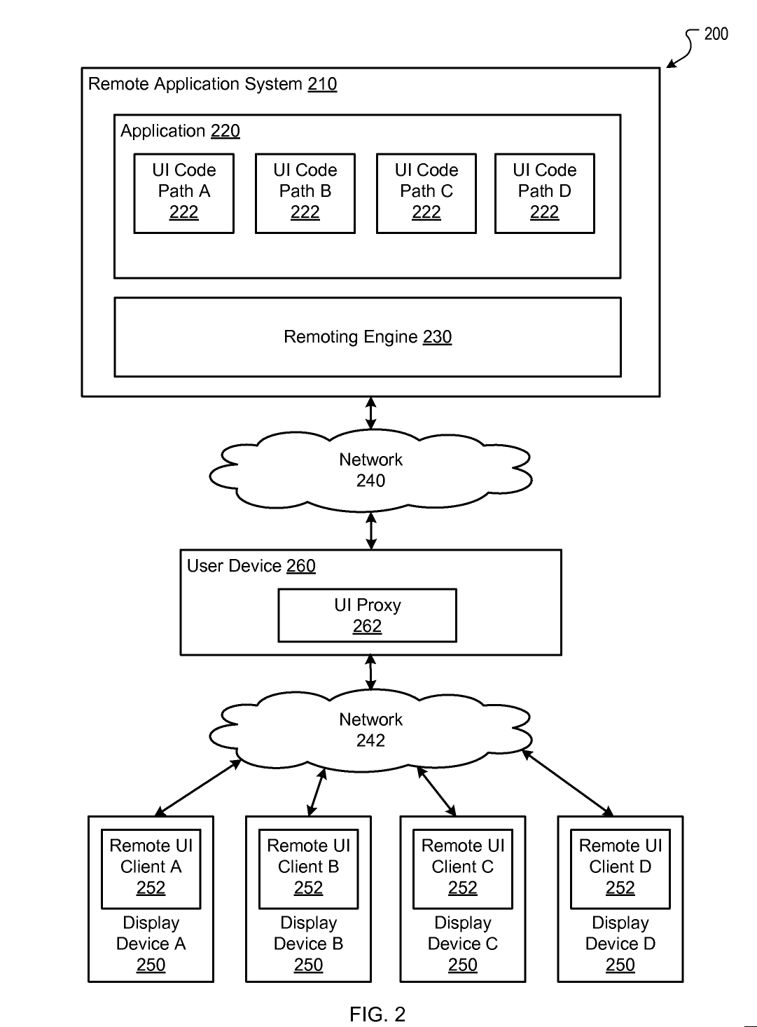

FIG. 2 shows an example environment 200 in which a remote application system 210 provides user interfaces generated by applications to display devices 250. The remote application system 210 is an example of a system implemented as computer programs on one or more locations, in which the systems, components, and techniques described below can be implemented.

In this example, the remote application system 210 manages the execution of one or more applications and allows users of display devices 250 remote from the remote application system 210 to access and interact with the applications managed by remote application system 210. The remote application system 210 can provide user interfaces generated by the applications for presentation on the display devices 250 and receive data identifying user events from the display devices 250 by way of user devices 260.

The remote application system 210 manages the execution of an application 220 that includes multiple user interface code paths 222. The user interface code paths 222 can be the same as, or similar to the code paths 122 of FIG. 1. In particular, each of the user interface code paths 222, when executed, generates a user interface that is specific to a respective class of display devices and/or specific to a particular mode, e.g., laptop or tablet mode, of the display device. In a particular example, the display devices 250 are vehicle-mounted displays and the user device 260 is a mobile communication device. In this example, the user device 260 allows a user to interact with the application 220 executed by the remote application system 210 in cars having different display devices with different display sizes and different input capabilities. For example, a user can interact with the application 260 using display devices in different rental cars.

The remote application system 210 also includes a remoting engine 230. The remoting engine 230 can be the same as, or similar to, the remoting engine 130 of FIG. 1. For example, the remoting engine 230 may perform the same functions as the remoting engine 130.

The example user device 260 includes a user interface proxy 262 that facilitates communication between the remote application system 210 and display devices 250 that have respective remote user interface clients 252 (e.g., that are the same as or similar to the remote user interface clients 152 of FIG. 1). In some implementations, the user interface proxy 262 is a special-purpose application that facilitates the communication.

The user device 260 can communicate with the remote application system 210 over a first network 240. The first network 240 may be a LAN, WAN, e.g., the Internet, a cellular data network, or a combination thereof. The user device 260 can communicate with the display devices by way of a direct wired or wireless connection or over a second network 242. The second network 242 may be a LAN, WAN, PAN, or other appropriate network. In a particular example, the first network 240 is a WAN, e.g., the Internet, and the second network 242 is a LAN or PAN, e.g., that connects a smartphone with a vehicle-mounted display.

In operation, the user interface proxy 262 can establish communication with a remote user interface client 252 of a display device 250 and act as a two way data communication bridge for the display device 250 and the remote application system 210. Once the communication link is established, the user interface proxy 262 may provide data identifying available applications to the display device 250. For example, the available applications may include applications that the user has designated for use in remoting to display devices 250. The display device 250 can display data identifying the applications, e.g., selectable icons. A user of one of the display devices 250 can submit a request to the remote application system 210 through the remote user interface client 252 executing on the display device 250 to access the application 220. For example, the request may be submitted in response to user interaction with the icon for the application 220. The request may be sent from the display device 250 to the user interface proxy 262. In turn, the user interface proxy 262 may send the request to the remote application system 210.

The remoting engine 230 receives the request, determines the display device class to which the requesting display device belongs and/or the mode of the display device, and causes the application 220 to generate a user interface by executing the user interface code path 224 belonging to the display device class and/or its mode. The remoting engine 230 then provides the user interface generated by the application 220 to the user interface proxy 262. In turn, the user interface proxy 262 provides the user interface to the remote user interface client 252 executing on the display device 250.

While the user interface is being displayed to the user, the remote user interface client 252 detects user events associated with the displayed user interface and provides data identifying the user events to the user interface proxy 262. In turn, the user interface proxy 262 provides the data identifying the user events to the remoting engine 230. The remoting engine 230 can provide the user event into an input to the application 220 and provide the input to the application 220. If the user input causes a change to the user interface, the remoting engine 230 receives the updated user interface data from the application 220 and provides the updated user interface data to the user interface proxy 262. In turn, the user interface proxy 262 provides the updated user interface data to the remote user interface client 252 for presentation to the user.

In some implementations, the user device 260 may execute some applications, while other applications are executed by the remote application system 210. In such implementations, when a request to access an application is received, the user interface proxy 262 may determine where the requested application is executed. If the application is executed by the user device 260, the user interface proxy 262 may cause the application to execute at the user device 260 and to generate a user interface for the application. If the application is executed by the remote application system 210, the user interface proxy 262 may send the request to the remote application system 210, as described above.

In some implementations, the user interface proxy 262 can handle initiating applications at the remote application system 210 and authenticating users with the remote application system 210. In this way, the display devices do not need to have mechanisms for network connectivity or session initiation with remote applications.

FIG. 3 is a flow chart of an example technique 300 for providing a user interface generated by an application to a display device. The example technique 300 is performed by a system of one or more computers or electronic devices. For example, the technique 300 may be performed by the user device 110 of FIG. 1.

The system receives a request to access an application managed by the system from a display device (step 302). For example, the request can be received by the system from a remote user interface client executing on the display device, e.g., one of the remote user interface clients 152 executing on one of the display devices 152 of FIG. 1. The request identifies the application to be launched and includes identifying information that characterizes the display device. In particular, the remote user interface client can be configured to detect identifying information about the display device and provide the identifying information to the system with the request. The identifying information can include the device type of the display device, e.g., television, vehicle-mounted display, and so on, and the input styles supported by the display device, e.g., touch input, mouse input, keyboard input, infrared (IR) remote, pushbutton input, remote control input, voice input, and so on. The identifying information can also include information characterizing the display of the display device, e.g., the size of the display, e.g., the x and y dimensions of the display, and the resolution of the display. In some implementations, the identifying information includes the mode of the display device, e.g., laptop or tablet mode.

The system determines that the application includes a respective user interface code path for each of a set of display device classes and/or for each mode of a display device (step 304). Generally, each of the display device classes is associated with one or more of display device type criteria, display criteria, or input style criteria that are supported by the application. A default or generic user interface may be remoted to display devices that are not directly supported by the application, e.g., display devices that do not meet the criteria of the display device classes supported by the application. In this way, the user will be able to access the application using the default or generic user interface, but with potential losses in fidelity for which the display device is capable.

In some implementations, each application managed by the system includes a respective code path for each of a predetermined set of display device classes. In some other implementations, however, different applications managed by the system may have different numbers of code paths for different display device classes. For example, one application may include one code path for televisions and a different code path for vehicle-mounted displays. A different application, however, may include a single code path for all display devices that accept touch and pushbutton input, but not remote control input. In addition, some applications may have a different user interface code path for different modes of the display devices. For example, the application may have a user interface code path for tablet mode and a different user interface code path for laptop mode for a particular display device or for multiple display devices that have both modes, e.g., multiple different multimode computers.

The system classifies the display device into an appropriate display device class using the identifying information received with the request (step 306). That is, the system selects one of the display device classes for which the application includes a user interface code path using the identifying information received with the request. In particular, the system determines a display device class for which the display device satisfies each of the criteria, e.g., the display device type criteria, the display size criteria, mode or the input style criteria, based on the identifying information for the display device.

The system causes the application to generate a user interface by executing the user interface code path corresponding to the appropriate display device class and/or appropriate mode for the display device (step 308). For example, if the display device is classified in a particular vehicle-mounted display device class, the application may execute the user interface code path that corresponds to the particular vehicle-mounted display device class. In another example, if a display device is classified as being in a particular multimode computer class and the display device is in laptop mode, the application may execute the user interface code path that corresponds to the laptop mode for the particular multimode computer class.

The system provides the user interface generated by the application for presentation on the display device (step 310). For example, the system can provide the user interface for presentation by the remote user interface client executing on the display device.

While the user interface is being presented on the display device, the system receives data identifying a user interaction with the user interface (step 312). That is, the remote user interface client executing on the display device is configured to identify user events, e.g., mouse clicks, keyboard key presses, swipes, double taps, audio, gestures, biometrics, fingerprints, temperature, humidity, gyroscopic motion, global positioning system information, camera/microphone capture or other user interactions with the user interface and provide the user events to the system. The user event can identify, e.g., the specific input and a location of the input.

The system provides the user interaction as an input to the application (step 314). In some cases, the user input may cause a change in the user interface generated by the application. For example, the user input may be for a navigation user interface displayed on a vehicle-mounted display and the user input may cause the user interface to scroll to a different map portion. In these cases, the system can provide user interface updates to the display device that cause the display device to display the updated user interface. Continuing the previous example, the user interface update may include the updated map portion. The system can repeat steps 312 and 314 for each subsequent user interaction received by the system while the user interface is being presented on the display device.

In some cases, a user event may cause a change in the identifying information for the display device. For example, the user may submit an input changing the orientation of the display, e.g., by turning a tablet. As another example, the user may submit an input changing the size of a user interface window in which the user interface data is displayed, e.g., resizing an application window on a desktop display or laptop. In another example, the user may remove a tablet of a multimode computer from its keyboard which causes the multimode computer to automatically switch from laptop to tablet mode. In these cases, the system can receive data identifying the user event and determine whether the user event has caused a different display device class and/or mode to be appropriate for the display device and, if so, cause the application to switch to executing the user interface code path corresponding to the different display device class or mode. If not, the system can rescale the user interface data generated by the display device so that it is appropriate for a display device having the changed identifying information.

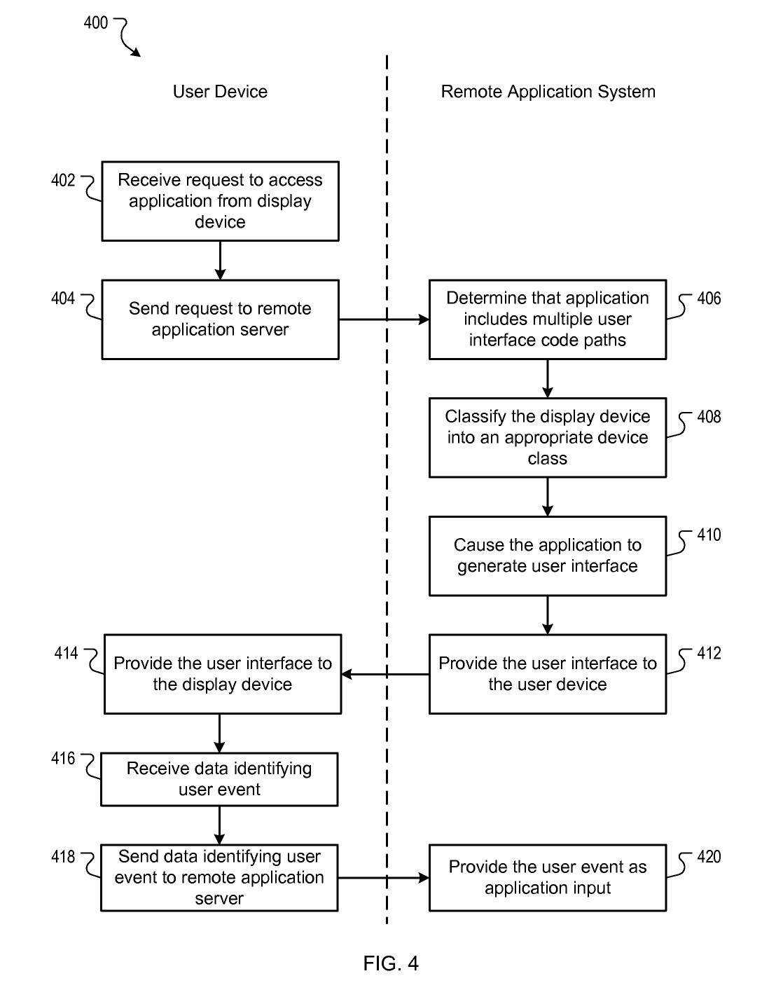

FIG. 4 is a flow chart of another example technique 400 for providing a user interface generated by an application to a display device. The example technique 400 is performed by a system of one or more computers. For example, the technique 400 may be performed by a user device, e.g., the user device 260 of FIG. 2, and a remote application system, e.g., the remote application system 210 of FIG. 2.

The user device receives a request to access an application from a display device (step 402). For example, the request can be received by the user device from a remote user interface client executing on the display device, e.g., one of the remote user interface clients 252 executing on one of the display devices 252 of FIG. 2. The request identifies the application to be launched and includes identifying information that characterizes the display device. In particular, the remote user interface client can be configured to detect identifying information about the display device and provide the identifying information to the user device with the request. As described above, the identifying information can include the device type of the display device, the input styles accepted by the display device, and/or information characterizing the display of the display device.

The user device sends the request to the remote application system (step 404). For example, a user interface proxy of the user device may send the request, including the data identifying information that characterizes the display device, to the remote application system.

The remote application system determines that the application includes a respective user interface code path for each of a set of display device classes and/or for each mode of a display device (step 406). The remote application system classifies the display device into an appropriate device class using the identifying information received with the request (step 408). That is, the remote application system selects one of the display device classes for which the application includes a user interface code path using the identifying information received with the request. In particular, the system determines a display device class for which the display device satisfies each of the criteria, e.g., the display device type criteria, the display size criteria, or the input style criteria, based on the identifying information for the display device, as described above.

The remote application system causes the application to generate a user interface by executing the user interface code path corresponding to the appropriate display device class and/or the appropriate mode for the user device (step 410). For example, in implementations where the application executes in a virtual machine assigned to the user, the system can launch an instance of the application in the virtual machine assigned to the user from whom the request was received and cause the application instance to execute the code path corresponding to the appropriate display device class.

The remote application system provides the user interface generated by the application to the user device (step 412). For example, the remote application system can provide the user interface to a user interface proxy executing on the user device.

The user device provides the user interface generated by the application for presentation on the display device (step 414). For example, the user interface proxy of the user device can provide the user interface for presentation by the remote user interface client executing on the display device.

While the user interface is being presented on the display device, the user device receives data identifying a user interaction with the user interface (step 416). As described above, the user event can identify the specific input and a location of the input.

The user device sends the data identifying the user interaction with the user interface to the remote application system (step 418). For example, a user interface proxy of the user device may provide the information to the remote application system.

The remote application system provides the user interaction as an input to the application (step 420). As described above, in some cases the user input may cause a change in the user interface generated by the application. In these cases, the remote application system can provide user interface updates to the user device. In turn the user device can provide the user interface updates to the display device. The user interface updates can cause the display device to display the updated user interface. The user device and remote application system can repeat steps 416-420 for each subsequent user interaction received by the user device while the user interface is being presented on the display device.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a user device, a user request to use a display of a first display device to access an application, wherein the application comprises a respective user interface code path corresponding to each of a plurality of display device classes, and wherein each user interface code path, when executed, generates a user interface that is specific to display devices of the corresponding display device class;
causing, by the user device, the application to generate a user interface for the display of the first display device by executing a first user interface code path, the first user interface code path corresponding to a first display device class to which the first display device is classified; and
providing, by the user device, a user interface for presentation on the display of the first display device in response to the user request.

2. The method of claim 1, wherein the application is executed on the user device.

3. The method of claim 2, wherein receiving the user request comprises receiving the user request from the first display device, the user request including information describing the display and input capabilities of the first display device, the method further comprising classifying the first display device into the first display device class based on the information describing the display and the input capabilities of the first display device.

4. The method of claim 2, further comprising:
while the user interface is presented on the display of the first display device, receiving, by the user device and from the first display device, data identifying a user event associated with the user interface; and
providing the input to the application.

5. The method of claim 2, further comprising:
receiving, by the user device, a user interface update from the application; and
providing the user interface update to the first display device.

6. The method of claim 1, wherein the application is executed by a remote application system that is in data communication with the user device and that is remote from the first display device.

7. The method of claim 6, further comprising:
providing, to the remote application system, a user interface request that requests the generation of the user interface and that includes information describing the display and input capabilities of the first display device; and
receiving the user interface from the remote application system through the user device.

8. The method of claim 1, wherein the user device comprises one of a mobile phone, a tablet computer, a game console, or a television set top box.

9. The method of claim 1, wherein the first display device comprises one of a vehicle-mounted display, a television, a head-mounted display, or a watch.

10. The method of claim 1, wherein the first display device operates in a first mode and a second mode different from the first mode, and wherein the first user interface code path corresponds to the first mode, the method further comprising:
receiving data indicating that the mode of the first display device has changed from the first mode to the second mode; and
causing the application to generate an updated user interface for the display of the first display device by executing a second user interface code path that corresponds to the second mode.

11. The method of claim 10, wherein the first mode is a laptop mode and the second mode is a tablet mode, wherein the first display device changed from the first mode to the second mode automatically in response to detection of removal of a tablet portion of the first display device from a keyboard of the display device.

12. A system comprising:
a user device that includes one or more data processing apparatus and a memory apparatus in data communication with the data processing apparatus, the memory apparatus storing instructions executable by the data processing apparatus that when executed by the data processing apparatus cause the data processing apparatus to perform operations comprising:
receiving a user request to use a display of a first display device to access an application, wherein the application comprises a respective user interface code path corresponding to each of a plurality of display device classes, and wherein each user interface code path, when executed, generates a user interface that is specific to display devices of the corresponding display device class;
causing the application to generate a user interface for the display of the first display device by executing a first user interface code path, the first user interface code path corresponding to a first display device class to which the first display device is classified; and
providing a user interface for presentation on the display of the first display device in response to the user request.

13. The system of claim 12, wherein the application is executed on the user device.

14. The system of claim 13, wherein receiving the user request comprises receiving the user request from the first display device, the user request including information describing the display and input capabilities of the first display device, the operations further comprising classifying the first display device into the first display device class based on the information describing the display and the input capabilities of the first display device.

15. The system of claim 12, wherein the application is executed by a remote application system that is in data communication with the user device and that is remote from the first display device.

16. The system of claim 15, wherein the operations further comprise:
providing, to the remote application system, a user interface request that requests the generation of the user interface and that includes information describing the display and input capabilities of the first display device; and
receiving the user interface from the remote application system through the user device.

17. The system of claim 12, wherein:
the user device comprises one of a mobile phone, a tablet computer, a game console, or a television set top box; and
the first display device comprises one of a vehicle-mounted display, a television, a head-mounted display, or a watch.

18. The system of claim 12, wherein the first display device operates in a first mode and a second mode different from the first mode, and wherein the first user interface code path corresponds to the first mode, the method further comprising:
receiving data indicating that the mode of the first display device has changed from the first mode to the second mode; and
causing the application to generate an updated user interface for the display of the first display device by executing a second user interface code path that corresponds to the second mode.

19. The system of claim 18, wherein the first mode is a laptop mode and the second mode is a tablet mode, wherein the first display device changed from the first mode to the second mode automatically in response to detection of removal of a tablet portion of the first display device from a keyboard of the display device.

20. A method comprising:
receiving, at a mobile device, a user request to access an application from a display of a vehicle-mounted display device, wherein the user request includes information describing the display of the display device and input capabilities of the vehicle-mounted display device;
causing the application to generate a user interface for the display of the vehicle-mounted display based on the information describing the display of the display device and input capabilities of the vehicle-mounted display device; and
providing the user interface for presentation on the display of the vehicle-mounted display device in response to the user request.
